(19) United States
(12) Patent Application Publication
(10) Pub. No.: US 2008/0193028 A1
(43) Pub. Date: Aug. 14, 2008

(54) Method of high quality digital image compression

(76) Inventor: Yin-Chun Blue Lan, Wurih Township (TW)

Correspondence Address: Chih-Ta Star Sung, Rm. 308, Bld. 52, No. 195, Sec. 4, Chung Hsin Rd., Juhdong, 310, omitted

(21) Appl. No.: 11/705,588

(22) Filed: Feb. 13, 2007

(51) Int. Cl. G06K 9/36

(52) U.S. Cl. 382/244

(57) ABSTRACT

This image compression applies a lossless compression algorithm and a lossy compression algorithm to code the differential value of the adjacent pixels. If lossy algorithm is selected, it codes the differential value of the present pixel and the reconstructed previous pixel. In quantizing the differential value of adjacent pixel components, a variable range of interval of value is predetermined with smaller interval range in values closer to “0” and larger interval range farer from “0”. The region with less mean variance, less quantization error will be allowed and the region with larger mean variance, more quantization error is allowed

### BACKGROUND OF THE INVENTION

1. Field of Invention

The present invention relates to digital image compression, and, more specifically to an efficient image compression method that results in a high image quality under a predetermined compression rate.

2. Description of Related Art

Compression has key benefits in cost reduction of storage device and speedup in accessing the compressed data. Most popular still image compression standards including JPEG, JPEG2000 are lossy algorithms which cause data difference between the decompressed and original image during the procedure of image compression. The data loss caused by lossy compression algorithm degrades the image quality which might not be acceptable in some applications.

There are very few lossless image compression algorithms of image data reduction. One of most commonly adopted approach is taking differential value between adjacent pixels and applying the so called “entropy coding” or “Variable Length Coding” method which applying shortest code to represent the most frequent happened pattern.

Lossy compression algorithms can achieve higher compression rate, said between 10 to 20 times, at the cost of sacrificing the image quality. Sharp image quality can be achieved by the lossless compression algorithm but the compression rate is most likely much lower than that of the popular lossy algorithms like JPEG or JPEG2000.

The method and apparatus of this invention of image compression is to achieve a reasonable higher compression rate compared to prior arts lossless compression algorithms without sacrificing much the image quality

### SUMMARY OF THE INVENTION

The present invention overcomes the drawback of the popular compression algorithms which introduce high degree of quality degradation. The present invention reduces the computing times compared to its counterparts in the image compression and decompression and reaches higher image quality.

The present invention of this high quality image compression and decompression applies a prediction mechanism to calculate the complexity of a group of pixels and decides whether they can be compressed by lossless or lossy compression algorithms.

For gaining higher accuracy, the present invention of this high quality image compression and decompression applies two compression engines, one lossless and another lossy compression methods, should lossless compression reaches the targeted data rate, its result is selected as the compressed output.

The present invention applies the following routing procedure to pixel by pixel achieve lossy but minimized error from truncation or quantization error:
Truncating predetermined bit length of the differential value of adjacent pixels and applying a VLC coding method to reduce the code length.
Decoding the compressed code and reconstructing the differential value. and
Calculating the differential value of the current pixel and the reconstructed adjacent pixel before applying quantization and VLC coding method.

According to one embodiment of the present invention, a group of pixels are compressed as a unit.

According to one embodiment of the present invention, a predetermined mapping table quantizes the differential value of adjacent pixels.

According to one embodiment of the present invention, the larger the differential value, the more error will be allowed.

According to one embodiment of the present invention, a predetermined group of differential values of pixels are converged into the same value and are coded by a VLC code.

According to another embodiment of the present invention, the region with less mean variance, less quantization error will be allowed and the region with larger mean variance, more quantization error is allowed.

It is to be understood that both the foregoing general description and the following detailed description are by examples, and are intended to provide further explanation of the invention as claimed.

### BRIEF DESCRIPTION OF THE DRAWINGS

FIG. 1 depicts a prior art, the JPEG still image compression procedure.

FIG. 2 depicts another prior art of image compression: differential value of adjacent pixels with variable length coding.

FIG. 3 illustrates the procedure of this invention of high quality image compression with a path of lossless compression and another path for lossy compression.

FIG. 4 depicts the procedure of a conceptual quantization/converging and VLC coding algorithm and the quantization/converging error.

FIG. 5 depicts the procedure of the quantization/converging and VLC coding algorithm with more balance error caused by quantization/truncation.

FIG. 6 illustrates the final procedure of the quantization/truncation with smaller value having smaller error and larger value having larger error.

FIG. 7 illustrates the procedure and block diagram of the quantization/truncation decision making with reference of the regional pattern complexity.

### DESCRIPTION OF THE PREFERRED EMBODIMENTS

Due to sharp quality and good immunity to the noise, and convenient in storage, the digital image has prevailingly become popular in mass applications like digital camera, digital camcorder, digital photo albums, scanner/printer/fax, image archiving and storage . . . etc.

For saving the requirement of density of storage device and time of transmission, image compression technology has been deployed to reduce the data rate of the digital image. In the past decades, many image compression algorithms have been applied to image applications. Some are lossy and very few are lossless. Lossy means the recovered or decompressed image from a compressed image will have data loss compared to the original image. ITU and ISO have developed and defined some image and video compression algorithms including JPEG, an still image compression standard and MPEG, the video compression standard. The JPEG image has widely applications with the cost of data loss compared to the original image.

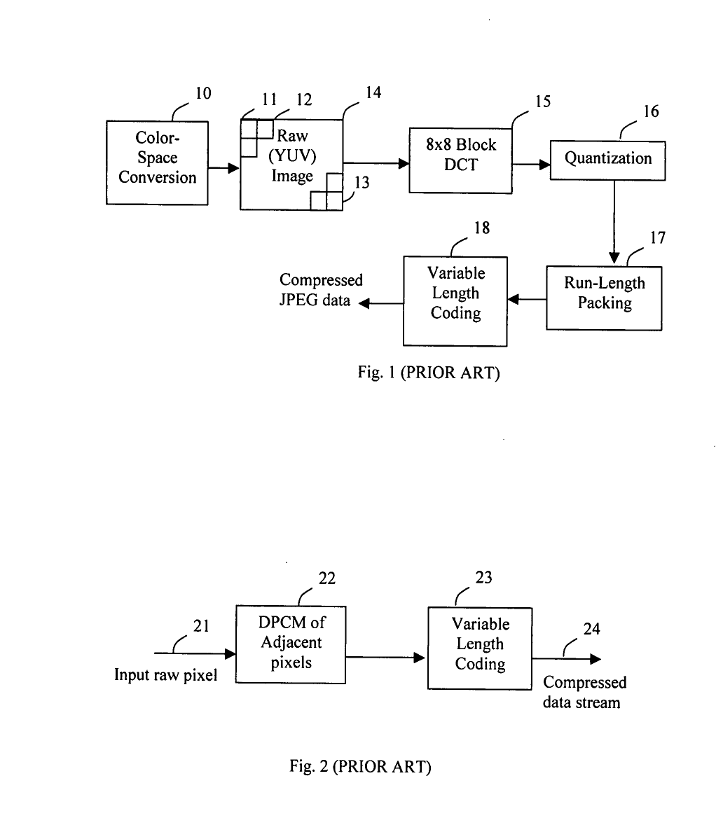

JPEG image compression as shown in FIG. 1 includes some procedures in compression. The color space conversion 10 is to separate the luminance (brightness) from chrominance (color) and to take advantage of human being's vision less sensitive to chrominance than to luminance and the can reduce more chrominance element without being noticed. An image 14 is partitioned into many units of so named “Block” of 8×8 pixels to run the JPEG compression.

A color space conversion 10 mechanism transfers each 8×8 block pixels of the R(Red), G(Green), B(Blue) components into Y(Luminance), U(Chrominance), V(Chrominance) and further shifts them to Y, Cb and Cr. JPEG compresses 8×8 block of Y, Cb, Cr 11, 12, 13 by the following procedures:

Step 1: Discrete Cosine Transform (DCT)

Step 2: Quantization

Step 3: Zig-Zag scanning

Step 4: Run-Length pair packing and

Step 5: Variable length coding (VLC).

DCT 15 converts the time domain pixel values into frequency domain. After transform, the DCT “Coefficients” with a total of 64 subbabd of frequency represent the block image data, no long represent single pixel. The 8×8 DCT coefficients form the 2-dimention array with lower frequency accumulated in the left top corner, the farer away from the left top, the higher frequency will be. Further on, the more closer to the left top, the more DC frequency which dominates the more information. The more right bottom coefficient represents the higher frequency which less important in dominance of the information. Like filtering, quantization 16 of the DCT coefficient is to divide the 8×8 DCT coefficients and to round to predetermined values. Most commonly used quantization table will have larger steps for right bottom DCT coefficients and smaller steps for coefficients in more left top corner. Quantization is the only step in JPEG compression causing data loss. The larger the quantization step, the higher the compression and the more distortion the image will be.

After quantization, most DCT coefficient in the right bottom direction will be rounded to “0s” and only a few in the left top corner are still left non-zero which allows another step of said “Zig-Zag” scanning and Run-Length packing 17 which starts left top DC coefficient and following the zig-zag direction of scanning higher frequency coefficients. The Run-Length pair means the number of “Runs of continuous 0s”, and value of the following non-zero coefficient.

The Run-Length pair is sent to the so called “Variable Length Coding” 18 (VLC) which is an entropy coding method. The entropy coding is a statistical coding which uses shorter bits to represent more frequent happen patter and longer code to represent the less frequent happened pattern. The JPEG standard accepts “Huffman” coding algorithm as the entropy coding. VLC is a step of lossless compression. JPEG is a lossy compression algorithm, the JPEG picture with less than 10× compression rate has sharp image quality, 20× compression will have more or less noticeable quality degradation.

The JPEG compression procedures are reversible, which means the following the backward procedures, one can decompresses and recovers the JPEG image back to raw and uncompressed YUV (or further on RGB) pixels.

Very few lossless image compression algorithms have been developed due to the following two factors:

The standard JPEG Image with 10× compression rate has still acceptable good image quality in most applications.

It is tough to achieve high compression rate of the lossless compression.

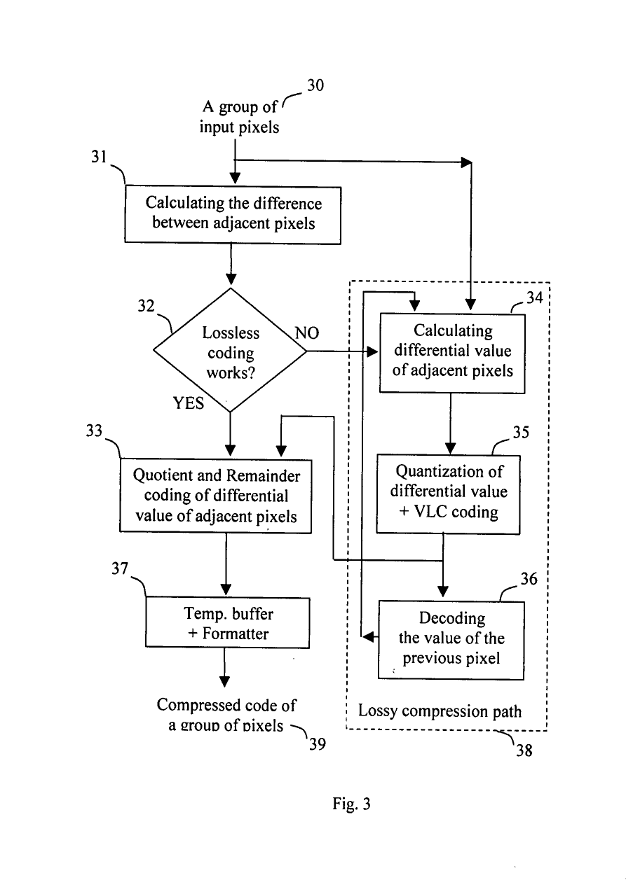

A well know prior art of the lossless image compression method is shown in FIG. 2 which calculates the differential value 22 of the input adjacent pixels 21 and runs the variable length coding 23, the VLC coding. A VLC coding uses the shortest code to represent the most frequent happen pattern, and longer code to represent the less frequent happen pattern. The disadvantage of the prior art in FIG. 2 is that it can not reach higher compression rate.

This invention of the image compression overcomes disadvantages of both lossy compression algorithm like JPEG and another prior art of VLC coding of the differential values of adjacent pixel in quality and compression rate issues. This invention applies a mixture of a new lossless compression and another new lossy compression algorithm to reach high image quality and reasonable high compression rate. As shown in FIG. 3, a group of input pixels 30 will be examined to see whether the complexity of pixels allows this group of pixels to be compressed by a lossless compression 32 algorithm under the predetermined bit rate which might be same to all group within a frame of picture or has variance from group to group. The differential value 31 of adjacent pixels is calculated first to be used as reference in deciding the compression mode. A lossless compression just codes the value of Quotient and Remainder 33 with the divider, for simplification in hardware implementation, is always shifted to be the power of “2” and used implicit way to code without coding the divider into the bit stream. For instant, a divider can always be predefined to be the average of current differential value of adjacent pixels and previous average divider as show in the equation below:

Div_{—}_{ⁿ}=(Div_{—}_{ⁿ⁻¹}+Diff_{—}_{ⁿ})/2

Should a lossless compression under a predetermined bit rate is not possible, then the lossy compression algorithm will play the role of compression.

It can also be possible that both lossless and lossy algorithms are implemented and in the end of compressing a group of pixels, should lossless compression path meets the targeted bit rate, the output will be selected to be the output of the compression, otherwise, the output of the lossy algorithm will be selected as the output of the compression.

In lossy compression path 38, the new coming pixel 30 is input to calculate the differential value 34 with the previous pixel which is reconstructed from a decompressed procedure 36. The calculated differential values are converged into predetermined values, or said are “quantized” 35 with each value having its predetermined corresponding value. The quantized values are input to a VLC coding 33 for coding the value of quotient and remainder, the same procedure as the lossless compression algorithm.

A temporary buffer stores and packs the compressed pixel data 37 before it is selected to be the output of a group of compressed pixels 39.

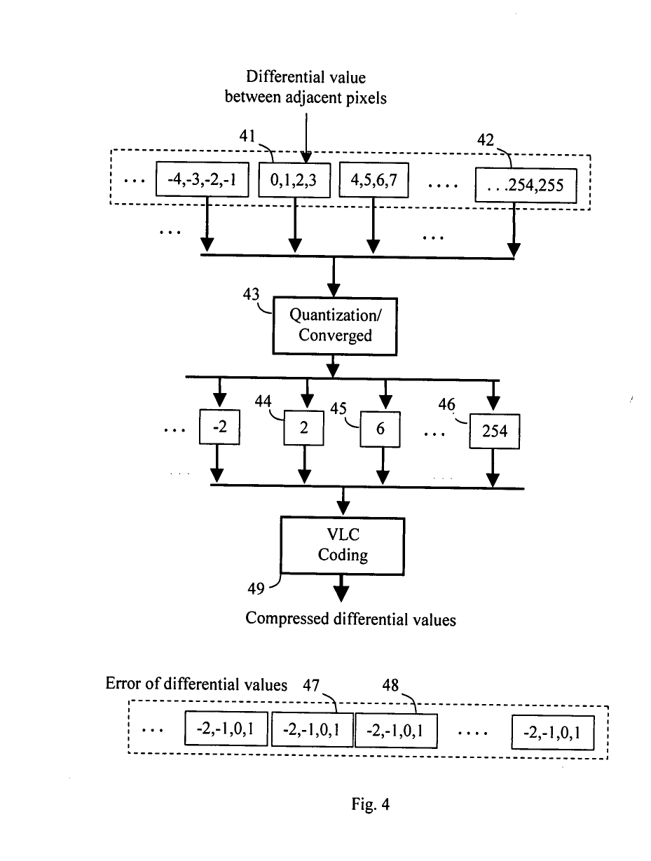

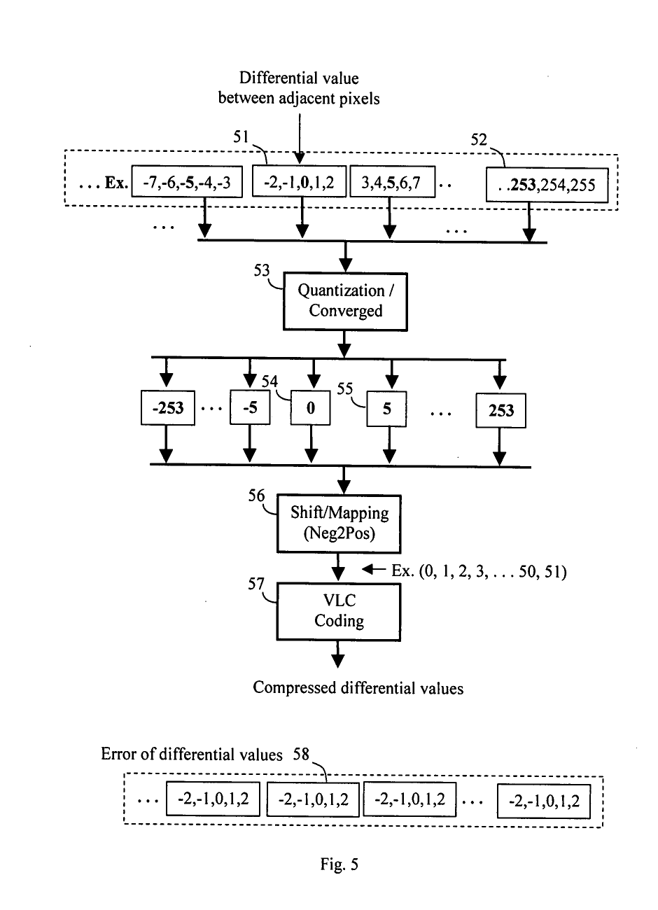

A conceptual diagram of quantization is show in FIG. 4, in which a group of numbers 41, 42 are converged or quantized 43 or said set to a predetermined value which is most likely the average 44, 45, 46 of the group of values. After quantization, the values will be converted to a predetermined range by mapping for the final VLC coding 49. For example, a group of (0, 1, 2, 3) can be converged to be (2, 2, 2, 2), and (4, 5, 6, 7) can be converged to (6, 6, 6, 6). The only procedure caused data error/loss is the quantization, the error in this example is fixed in the range of (−2, −1, 0, 1) 48, 49 for all range of values. It is obvious that in this example, the error ranges unbalance from −2 to +1, and there is room to improve the quality or said to minimize the error. FIG. 5 illustrates another quantization procedure used in this invention with higher accuracy and better for VLC coding which included a group of numbers in a balance situation, for example a group of {−2, −1, 0, 1, 2} 51 and . . . (251, 252, 253, 254, 255) 52 and after converging/quantizing 53 to single number each group 54, 55, the numbers become . . . −253, . . . −5, 0, 5, . . . 253. This quantized numbers can then be shifted or said mapped to be predetermined values 56. With this shifted range, the quantized error becomes balanced with error of (−2, −1, 0, 1, 2) 58 which has less numbers to be coded and when applying the VLC coding 57, the code will be shorter.

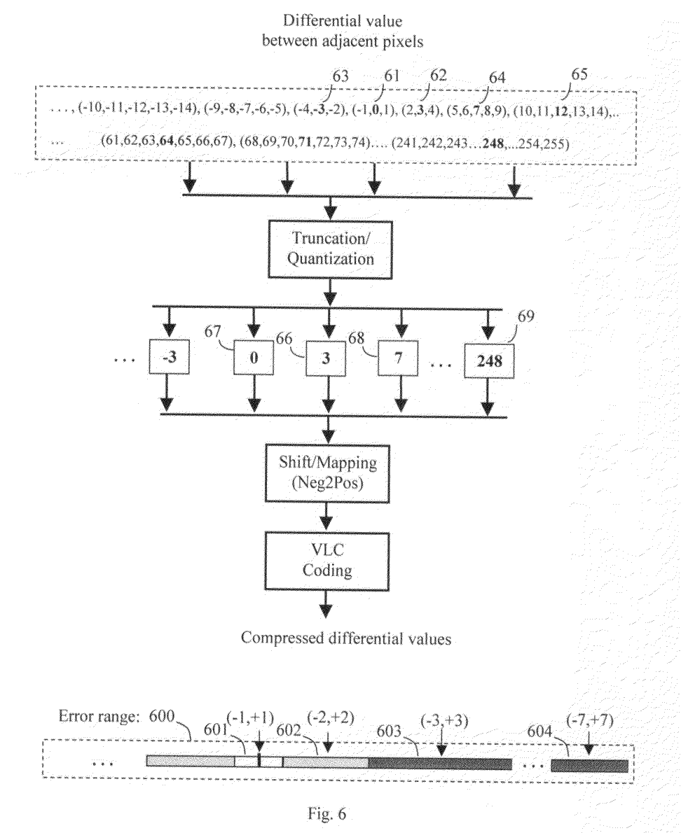

For further increasing the compress rate or from the other hand said enhancing the image quality in lossy compression or said in quantization, a group of variable numbers of differential values of adjacent pixels can be converged into predetermined value. From the other hand, a group of differential values closer to “0” for instance a range of (−7, +7), divided to be group of (−7, −6, −5), (−4, −3, −2), (−1, 0, 1), (2, 3, 4), (5, 6, 7) can be converged into predetermined values of (−6, −3, 0, 3, 6) and the error compared the original value will be (−1, 0, 1, −1, 0, 1, −1, 0, 1, −1, 0, 1) which are high accurate numbers. IN the second range of value of said (−32, −8) and (8, 32), every 5 numbers are converged to a predetermined value and results into the final values of (−30, −25, −20, −15, −10, +10, +15, +20, +25, +30) and the quantization of the corresponding original values will be (−2, −1, 0, 1, 2, −2, −1, 0, 1, 2, −2, −1, 0, 1, 2, −2, −1, 0, 1, 2, −2, −1, 0, 1, 2, −2, −1, 0, 1, 2, −2, −1, 0, 1, 2, −2, −1, 0, 1, 2, −2, −1, 0, 1, 2, −2, −1, 0, 1, 2). The larger the differential values, the larger range of numbers will be converged to a predetermined number and the larger the quantization error will be predicted. FIG. 6 shows an example of this high image quality of image quantization in compression. A group of smaller numbers close to “0” are included into a group 61, 62, 63 (for example, 3 numbers), the larger the values, the more numbers will be included into a group 64, 65 which might have 5 or 7 numbers together being converged to a predetermined values 66, 67, 68, 69, for example, (−248, . . . −71, −64, −12, −3, 0, 3, 7, 12, 64, 71, . . . 248). And the quantization errors 600 will range from (−1, +1) 601, (−2, +2) 602, (−3, +3) 603 . . . might to (−7, +7) 604.

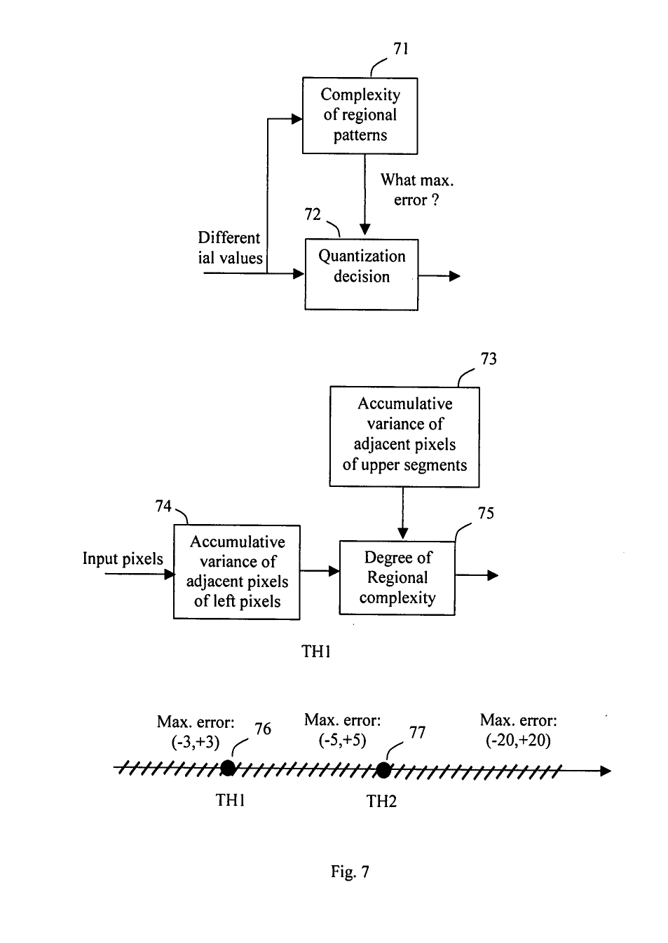

In some regions or so named “Homogenous area” of a frame of image, continuous tone with very few or even no difference between adjacent pixels will have high sensitivity to even small error which is caused by quantization. While the region with high complexity can tolerant more error without being noticed visually. To avoid triggering more visual artifact especially in the homogenous area, a mechanism of analyzing the pattern complexity 71 as shown in FIG. 7 is applied to be reference for the quantization decision 72. For this to be realized with reasonable cost and with simplicity, accumulative variance of adjacent pixels of a predetermined amount of upper lines 73 of the same segment and accumulative variance of the left adjacent pixels 74 are input to calculate the regional complexity 75. Which means, if the same segments of upper lines or left pixels have little variance smaller than a predetermined threshold TH1, TH2, 76, 77 there will be a corresponding max. tolerance of quantization errors or truncation bit length for instance (−3, +3), (−5, +5), . . . (−20, +20).

This description of invention is available based on pixel components of Y, U and Vas well as Red, Green and Blue components.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of reducing the bit rate of a digital image, comprising:
partitioning a frame of pixels into a predetermined amount of groups of pixels with each group having a predetermined amount of pixel components and compressing the image frame group by group with the following procedures:
applying a lossless compression algorithm to the targeted group of pixels which includes calculating the differential value of adjacent pixels and a variable coding the differential value;
applying a lossy compression algorithm to the targeted group of pixel components includes the following procedures:
calculating the differential value of adjacent pixels;
converging the calculated differential value to a predetermined value;
coding the converged value by a variable coding method; and
decompressing the latest pixel by the reversed procedure of above compression steps to recover the pixel component value to be the referencing pixel for calculating the differential value between itself and the targeted coming pixel; and
if the bit rate of the coded group of pixels with lossless compression algorithm is within the budgeted number, the code of the lossless compression algorithm is selected to be the output of the compressed code, otherwise, the result of the lossy algorithm is selected to be the output of the compression.

2. The method of claim 1, wherein the selected lossless compression method codes only the quotient and remainder of each pixel component by dividing the differential value of current pixel component by the predicted previous divider.

3. The method of claim 2, wherein the predictive present divider value is an average of the previous accumulative average and the value of current pixel component.

4. The method of claim 1, wherein the lossy algorithm firstly calculates the differential value between the current pixel component and the reconstructed adjacent pixel component.

5. The method of claim 1, wherein the selected lossy algorithm quantizes the differential value according the calculated bit number budgeted for the group of pixels.

6. The method of claim 1, wherein the selected lossy algorithm quantizes the differential value by mapping the differential value to a predetermined value of that corresponding interval.

7. The method of claim 8, wherein a larger quantization interval is applied when the budgeted bit is less and a smaller quantization interval is applied when the budgeted bit is more.

8. A method of quantizing a group of pixels of an image to reduce the range of values of pixel components, comprising:
calculating the differential value of the time domain values of the targeted pixel and the adjacent pixel;
determining the range of each interval of values for converging the differential values to the average value of the corresponding interval and following the principle of:
the lower the values, the small range the interval;
the higher the values, the large range the interval; and
“0” becomes the center of the first range of interval.
comparing the differential value of adjacent pixels to the predetermined range of intervals and determining the converging value to represent that differential value.

9. The method of claim 8, wherein the quantization interval size varies according to the range of differential values with the range including “0” the smallest range.

10. The method of claim 8, wherein the close to “0” value, the smaller the interval size will be and the farer from “0” value, the larger the interval size.

11. The method of claim 8, wherein bit rate estimation mechanism is applied to predict how many bits the current group of pixel components should be coded and applying the quantization mapping intervals accordingly.

12. The method of quantization step decision making for each region with different complexity, comprising:
calculating the accumulative complexity of each group of pixels of at least two upper lines of pixels;
calculating the accumulative complexity of the previous at least two pixels; and
determining the maximum tolerance of quantization error of the targeted group of pixel components by the following principle: the region with less mean variance, less quantization error will be allowed and the region with larger mean variance, more quantization error is allowed.

13. The method of claim 12, wherein the accumulative complexity is measured by summing the differential value of adjacent pixels of a group of pixels of upper lines and previous pixels in the same line.

14. The method of claim 12, wherein when the accumulative complexity is less than the first threshold, a predetermined first quantization step is applied to the corresponding group for converging differential values, when the accumulative complexity is less than the second threshold, a predetermined second quantization step is applied to the corresponding group for converging differential values, . . . etc.

15. The method of claim 12, wherein the amount of values to be converged to a predetermined value is odd number.

16. The method of claim 12, wherein the amount of values to be converged to a predetermined value is odd number.

17. The method of claim 12, wherein in the homogenous area, less quantization error is allowed.
